(19) United States
(12) Patent Application Publication
(10) Pub. No.: US 2024/0321017 A1
(43) Pub. Date: Sep. 26, 2024

(54) WHEEL END, HUB CAP, IDENTIFICATION SYSTEM AND INFORMATION SYSTEM

(71) Applicant: SAF-HOLLAND GmbH, Bessenbach (DE)

(72) Inventors: Nico Kraus, Mespelbrunn (DE); Thomas Piroth, Aschaffenburg (DE)

(21) Appl. No.: 18/575,924

(22) PCT Filed: Aug. 2, 2022
(86) PCT No.: PCT/EP2022/071699

§ 371 Date: Jan. 2, 2024

(30) Foreign Application Priority Data
Aug. 6, 2021 (DE) 10 2021 120 484.4

(51) Int. Cl. G07C 5/00; B60B 7/00; B60B 27/02

(52) U.S. Cl. CPC G07C 5/008; B60B 7/0013; B60B 27/02

(57) ABSTRACT

A wheel end for a commercial vehicle wheel end includes a wheel bearing arrangement, a hub, a hub cap and an NFC tag, wherein the hub is held rotatably about an axle of rotation by the wheel bearing arrangement, wherein the hub cap is fixed or fixable to the hub, and wherein the NFC tag is mounted on an element of the wheel end including the hub cap or the hub.

### BACKGROUND

The invention relates to a chassis arrangement, a wheel end, a hub cap, an identification system and an information system.

Wheel ends are already known from the prior art. These comprise the components of the axle that axially contact an axle and the components carried by the axle. These wheel ends contain components such as a wheel bearing or brake pads. Over time, however, the markings on these wheel ends become increasingly difficult to recognize, especially on commercial vehicles, so that the effort required to identify the wheel end or its components becomes ever greater, as, for example, serial numbers become clogged or unrecognizable due to dirt and/or grease.

It is therefore the object of the present invention to simplify the identification of a chassis arrangement or a chassis component, in particular a wheel end and its components.

### SUMMARY

According to an aspect of the invention, a chassis arrangement, in particular a wheel end, or a chassis component, wherein an NFC tag is arranged on or in a part of the chassis arrangement or in or on the chassis component. In particular, a chassis arrangement can be a wheel end. A chassis arrangement may comprise those or some of the components of a vehicle or a chassis which serve to support a frame or a body of a vehicle with respect to a roadway or a ground. The individual components of the chassis arrangement can be chassis components or be formed exclusively by chassis components. The chassis components are in particular those components of a vehicle which are located in the support force flow between the ground or the roadway and the frame or the body of the vehicle. The chassis arrangement may comprise some of the following chassis components and/or the or one of the NFC tags of the invention may be arranged on one or some of the following chassis components, a spring, in particular an air spring, a control arm, in particular a trailing arm, a support bracket, a wheel bearing, a wheel end, a brake disk, an axle, a shaft, a shock absorber, a brake drum, a brake carrier, a hub cap, a wheel hub, a brake shoe and/or a brake lining.

A further aspect of the invention can relate to a commercial vehicle, in particular a commercial vehicle trailer, wherein the commercial vehicle can have a wheel end and/or a hub cap as described above or below. In particular, the commercial vehicle may be a semi-trailer. This is particularly advantageous, since the identification or reading of information from the wheel end of a semi-trailer is usually only possible with a high expenditure of time.

According to one aspect of the invention, a wheel end, in particular a commercial vehicle wheel end, is provided, comprising a wheel bearing arrangement, a hub, a hub cap and an NFC tag, wherein the hub is held rotatably about an axle of rotation by the wheel bearing arrangement, wherein the hub cap is fixed or fixable to the hub, wherein the NFC tag is mounted on an element of the wheel end, in particular on the hub cap or the hub. A commercial vehicle within the meaning of the invention is in particular a towing vehicle, preferably roadworthy and/or road-bound, or a trailer with a permissible total mass of more than 3.5 tons, preferably more than 7.5 tons and particularly preferably more than 15 tons. In particular, the wheel ends form the radially outward-facing components of an axle or shaft unit. The wheel ends serve in particular to support and/or brake a wheel of the wheel end or of the vehicle to which the wheel end belongs. In other words, the wheel ends therefore comprise in particular, inter alia, the brake system, the wheel hubs, the wheels to be supported and/or the wheel bearing arrangement of an axle or a shaft and/or the axle end or the shaft end of the axle or the shaft. These elements of the wheel end can be referred to as wheel end elements or elements of the wheel end. Such an axle or shaft usually has a first and a second wheel end at the opposite ends. Each axle of a vehicle therefore usually has a left and a right wheel end. Advantageously, the wheel end is a commercial vehicle wheel end. The wheel end can therefore be designed in such a way that it can withstand the mechanical loads of a commercial vehicle and/or be mounted on a commercial vehicle. Therefore, an ordinary motor vehicle wheel end or even a passenger car wheel end differs from a commercial vehicle wheel end in the meaning of the invention. The wheel bearing arrangement of the wheel end serves to hold the hub rotatably about the axle of rotation, in particular on the shaft or axle of the wheel end. In other words, the wheel bearing arrangement fixes the hub in such a way that the hub is held or limited or restricted in its translational mobility, in particular along the axle of rotation and perpendicular to the axle of rotation, by the wheel bearing arrangement. The wheel bearing arrangement is advantageously arranged in a recess or an opening in the hub, wherein this recess or this opening can extend along the axle of rotation. The wheel bearing arrangement advantageously comprises one or a plurality of wheel bearings, which may in particular be roller bearings. In order to prevent engagement in the aperture or opening of the hub, a hub cap is advantageously provided, which is fixed or can be fixed in a form-fitting and/or force-fitting manner relative to the hub, in particular directly on the hub. For example, the hub cap can therefore positively prevent engagement in the aperture or opening of the hub. The hub cap can advantageously be fixed to the hub via a latching mechanism, such as a clip lock or a clip fastening. Such a fastening can be formed, for example, by (clip) projections and complementary grooves. Furthermore, the wheel end also has an NFC tag, which is mounted or fixed to an element of the wheel end. By using an NFC chip, which can also be designed as an NFC tag or can be designated as such, wheel end-specific information, which is advantageously stored on the NFC tag, can be read out in a very simple and reliable manner. By using an NFC tag, especially in comparison to an RFID chip, it can be achieved that the information of the NFC tag is only available for a short range, so that data security can be increased as a result. Furthermore, the provision of information or identification information by means of an NFC tag is particularly resistant to soiling and durable compared to conventional means of providing information, such as serial numbers or QR codes, so that it can also ensure secure provision of information over a long period of time, which is particularly advantageous for commercial vehicles, and at the same time also meets high data protection requirements—through the use of an NFC tag. Advantageously, the NFC tag can be mounted on the hub cap or the hub. By mounting or fixing the NFC tag to the hub cap or the hub, an information reading device or an information retrieval unit, which can be a smartphone in particular, can be brought into the immediate vicinity of the NFC tag in a simple manner, so that the information can be read securely from the NFC tag. Immediate vicinity in the meaning of the invention is understood to mean in particular that the relevant distance between the two objects or areas is a maximum of 4 cm, particularly preferably a maximum of 2 cm and particularly strongly preferred a maximum of 1 cm.

Preferably, the NFC tag is mounted by bonding and/or irreversibly. The term “mounted irreversibly” means in particular that the mounting of the NFC tag cannot be removed non-destructively. By using an irreversible mounting or attachment of the NFC tag, a particularly durable and secure mounting can be achieved. This is particularly important if the NFC tag is mounted on a rotating component, in particular an axle, a shaft and/or a hub and/or a hub cap. Preferably, the NFC tag is mounted or held in place by means of a material-locking connection or adhesive bond. The advantage of a material-locking connection or bonding is that the noise affecting the information signal can be reduced and thus the data transmission capability of the NFC tag can be increased. Basically, the noise reduction and/or the increase of a noise signal ratio is particularly desirable in the area of a wheel end, because there are many metallic components in the area of the wheel end that can significantly interfere with data transmission. However, this disruptive data transmission is particularly important to avoid with NFC tags, as NFC tags have an inherently short data transmission range, which is further reduced by disruptive noise ratios and/or noise-inducing objects.

Preferably, the NFC tag is a passive tag. In particular, a passive tag means that the tag is able to generate a wireless response signal based on received wireless signals, wherein the energy for the response is generated or taken from the received data signal. Alternatively or additionally preferably, an NFC tag is passive if it has no external energy connection. By using a passive tag, a particularly small and space-saving design can be achieved. In addition, this also makes it possible to provide information over a very long period of time, as the information provision period no longer depends on the energy provision capability of an external energy source, such as a vehicle battery. In addition, a passive design of the tag is particularly desirable when an NFC tag is attached to a rotating component, as this avoids mechanical loads caused by rotation on an external energy source, such as a battery or electrical cables.

Advantageously, the NFC tag is a low-frequency tag or a high-frequency tag. A low-frequency tag is a tag whose data signal is transmitted or located in the kHz range, in particular in the range of 120 to 140 kHz. By using a low-frequency tag, particularly good data security can be achieved, as low-frequency tags can only provide a small information range. Therefore, the distance that a data reading device must be from the NFC tag is particularly short. This short range or the close proximity of a data reading device to the NFC tag makes it particularly easy to increase data security.

Alternatively, the NFC tag is preferably a high-frequency tag. In particular, a high-frequency tag is an NFC tag whose information is transmitted in a frequency range between 9 and 15 MHz. By using a high-frequency tag, a particularly large bandwidth of transmission rates and read distances can be realized, so that the variety of information and/or the accessibility of information can be increased. In particular, this makes it possible to position the NFC tag in areas that are particularly well protected against environmental influences, while at the same time ensuring secure data transmission.

Advantageously, the wheel end has an axle end of an axle, wherein the axle end is advantageously spaced at least 2 cm, preferably at least 4 cm and particularly preferably at least 6 cm from the NFC tag and/or wherein the NFC tag is mounted directly or indirectly on the axle end. An axle end is to be understood in particular as the area of the axle which forms the distal 10% of the length of the axle and/or those areas of the axle which form the distal end of the axle itself in the axial direction. Alternatively, the axle end can also preferably be that area of the axle which is at a maximum distance of 30 cm, preferably at a maximum distance of 15 cm and particularly preferably at a maximum distance of 10 cm, from the distal end of the axle in the axial direction. The axial direction is in particular parallel or congruent with the axle of rotation of the wheel of the wheel end and/or the wheel to be supported by the wheel end, wherein the axle of rotation of the wheel of the wheel end and/or the wheel to be supported by the wheel end can also be referred to in simplified terms as the axle of rotation. If the NFC chip, which can also be referred to as an NFC tag, is at least 2 cm away from the end of the axle, this separation can achieve good signal receptivity of the NFC tag. If the end of the axle is at least 4 cm away from the NFC chip, this surprisingly results in a particularly good noise-to-signal ratio. In order to achieve particularly easy installation of the NFC tag, it should be at least 6 cm away from the axle end of the wheel end. Alternatively or additionally preferably, the NFC tag should not be more than 30 cm away from the axle end in order to achieve reliable and simple identification of the wheel end.

Conveniently, the NFC tag has a maximum distance from the axle of rotation, in particular in a radial direction, of 35 cm, preferably 25 cm and particularly preferably 10 cm. The radial direction is in particular the direction that is oriented radially away from the axle of rotation or the axial direction. The axle of rotation and the axial direction can be congruent. If the distance of the NFC tag is a maximum of 35 cm from the axle of rotation or the axial direction, this can achieve particularly good mechanical and physical accessibility of the NFC tag. If the NFC tag has a maximum distance of 25 cm from the axle of rotation or the axial direction, this allows the NFC tag to be mounted particularly easily and simply. In order to achieve a particularly compact and space-saving arrangement, the maximum distance from the axle of rotation or the axial direction, in particular in the radial direction, should be a maximum of 10 cm.

Preferably, the NFC tag is arranged lying on the axle of rotation and/or is intersected by the axle of rotation. In other words, the NFC tag can be placed directly on the axle of rotation and/or is at least cut by the “imaginary” extension of the axle of rotation. By arranging the NFC tag on the axle of rotation and/or by cutting the NFC tag through the axle of rotation, a particularly compact and space-saving wheel end arrangement can be achieved.

Advantageously, the hub cap is non-metallic, in particular made of plastic. This allows particularly good information transmission to be achieved, as metallic objects, in particular metallic hub caps, introduce particularly high levels of interference into the signal, so that they reduce the noise-to-signal ratio. The information transmission can therefore be improved by designing the hub cap from plastic. A further advantage of a plastic hub cap is the ease of installation and the low cost of such a design. A hub cap made of plastic is understood to mean that at least 75%, in particular 80%, of the weight, preferably at least 90% of the weight and particularly preferably 95%, and particularly strongly preferably 99%, of the weight is made of plastic. A non-metallic can be understood to mean that at least 75%, in particular 80%, of the weight, preferably at least 90% of the weight and particularly preferably 95%, and particularly strongly preferably 99%, of the weight consists of a non-metallic material.

Advantageously, the NFC tag is mounted on the hub cap on a side facing the axle and/or on an inner side of the hub cap. By arranging the NFC tag on the hub cap and at the same time on a side facing the axle and/or on an inside of the hub cap, particularly good shielding of the NFC tag against the effects of weather can be achieved. A side of the hub cap facing the axle means in particular that the outward-facing normal of the mounting surface of the hub cap points at least in the direction of the axle. An inner side of the hub cap is understood to be a side which in particular faces the axle and/or which is kept free or shielded from external environmental influences by the hub cap itself.

The surface on which the NFC tag is arranged is conveniently designed to be flat so that the NFC tag can be mounted easily.

Advantageously, at least in a mounted state, a seal is arranged between the hub cap and the hub. This can achieve particularly good shielding of the inner area of the hub cap, so that the influence of the weather on the NFC tag can be further reduced. Such a seal can be an O-ring, for example. Alternatively or additionally preferred, the seal is in particular a static seal, which at least makes contact with the hub cap and/or the hub.

Advantageously, the hub has through-openings, wherein the NFC tag is mounted in or in the immediate vicinity of a through-opening. The through openings of the hub are in particular ventilation openings, which are therefore advantageously open to an air flow in a mounted state. For example, these through-openings can be used to cool an existing brake, in particular a drum brake or a disk brake of the wheel end. By arranging the NFC tag in or in the immediate vicinity of a through-opening, particularly good accessibility and therefore simple and reliable data transmission between the NFC tag and an information retrieval unit, which can be a smartphone or a readout device in particular, can be achieved.

Advantageously, a wheel, in particular a twin wheel, is fixed to the hub. By using a twin wheel, a particularly resilient and mechanically reliable unit can be achieved, so that such a wheel end is particularly predestined for use in commercial vehicles, in particular in semi-trailers. Alternatively preferably, the wheel can also have single tires. This makes it possible to achieve a particularly cost-effective wheel.

Preferably, the information of the NFC tag according to the invention includes identification information of the wheel end and/or one or some or all components of the wheel end or a chassis arrangement or one or many chassis components or vehicle components, in particular a spring, an air spring, a brake, a fifth wheel plate, a kingpin and/or a handlebar. These chassis components or vehicle components may belong to the vehicle to which the NCF tag is attached or to which the wheel end belongs.

A further aspect of the invention may relate to a hub cap, wherein an NFC tag is mounted on the hub cap. In particular, such an NFC tag and/or the hub cap may have the features, advantages and embodiments described above and below in connection with the hub cap and/or the NFC tag. By arranging an NFC tag on a hub cap, the advantages and/or embodiments already described can be achieved in particular. In addition, by mounting the NFC tag on the hub cap in this way, it can also be achieved that the NFC tag is already pre-assembled during assembly of a wheel end and can thus be mounted or fixed to a wheel end in a cost-effective manner.

A further aspect of the invention can relate to the use of an NFC tag in the commercial vehicle sector. Advantageously, the NFC tag is used to identify a wheel end component. By using an NFC tag in the commercial vehicle sector, the features, advantages and embodiments already described above and below can be achieved. In addition, the use of an NFC tag can also create a virtual product experience for a customer, commercial vehicle owner or commercial vehicle user, which they perceive as particularly advantageous. Such a virtual customer experience can be achieved, for example, by an identification system described below or by an information system.

A further aspect of the invention may relate to an identification system for identifying a wheel end component or a wheel end. Such a wheel end component is also referred to as an element of the wheel end in the context of the invention. The identification system for identifying a wheel end component comprises at least a hub cap as described above and/or a wheel end as described above and below and an information retrieval unit, in particular a smartphone, wherein the NFC tag is adapted to transmit information, in particular concerning the wheel end or a component of the wheel end, to the information retrieval unit. In other words, the identification system can ensure that a request from the information retrieval unit to the NFC tag causes the NFC tag to transmit information specific to the wheel end or wheel end component, in particular identification information, to the information retrieval unit. The identification system therefore makes it easy to identify a wheel end component and/or the wheel end and/or the commercial vehicle or the vehicle with the wheel end. The information retrieval unit can be a card reader, an information reader or preferably a smartphone. The possibility of using a smartphone to retrieve information or to identify a wheel end component or an element of the wheel end makes it easy to provide information accessibility to a common user, in particular without expensive special devices. Advantageously, the NFC tag only transmits information to the information retrieval unit if the information retrieval unit provides a specific security code for the NFC tag. This can further increase the data security of the system.

Preferably, the information of the NFC tag according to the invention includes identification information of the wheel end and/or one or some or all components of the wheel end or a chassis arrangement or one or many chassis components or vehicle components, in particular a spring, an air spring, a brake, a fifth wheel plate, a kingpin and/or a handlebar. These chassis components or vehicle components can belong to the vehicle to which the NCF tag is attached or to which the wheel end belongs. Such identification information can be, for example, the serial number, the vehicle registration number, the date of manufacture or the manufacturer's responsibility. The identification information is particularly preferably unique information. Unique information can be used to identify a wheel end and/or a wheel end component and/or a wheel end element exclusively or unambiguously. In other words, for example, unique identification information can be assigned or allocated exclusively to one unit. Such unique identification information can prevent confusion and achieve unambiguous identification of the desired component.

A further aspect of the invention may relate to an information system. Advantageously, an information system comprises a central unit, which may in particular be a server, and an identification system as described above and below, wherein the information retrieval unit is adapted to transmit the information received from the NFC tag or parts or all of the information received from the NFC tag to the central unit, and/or wherein the central unit is designed to access an information memory, in particular a database, of the central unit on the basis of the information received from the information retrieval unit and to transmit data from the information memory, in particular the database, to the information retrieval unit as a function of the information received from the information retrieval unit. In other words, an information system may have a central unit which contains and/or can retrieve centrally stored information. Therefore, if the information retrieval unit receives information from the NFC tag, it can transmit a request, which can be based on the received information, to the central unit, wherein the central unit accesses the data memory accessible by it as a function of this request and transmits and/or provides information from the data memory of the information retrieval unit depending on the request and/or information. This type of configuration makes it possible to reduce the data to be stored on the NFC tag while still being able to provide a large amount of data on the information retrieval unit. For example, this data stored and/or retrievable by the central unit can relate to and/or be a wide variety of identification- and/or condition- and/or manufacturing-specific data with regard to the wheel end component or the wheel end element and/or the wheel end and/or the vehicle, in particular commercial vehicle, on which the wheel end is mounted. Such an arrangement therefore makes it possible for a customer to obtain a comprehensive information experience with regard to the wheel end. This customer experience and/or this comprehensive provision of data for the customer with regard to his wheel end is therefore particularly advantageous, because the customer can view or retrieve data about “his” axle head quickly and yet safely without any possible confusion.

Advantageously, the data from the database that is transmitted to the information retrieval unit includes a date of manufacture, an identification number, a manufacturing site, a mileage, maintenance information and/or a serial number of the wheel end or a component of the wheel end and/or all components of the wheel end. This information or data can be used to provide a wide range of information to a customer and/or an operator.

### BRIEF DESCRIPTION OF THE DRAWINGS

Further advantages and features of the present invention are shown in the following description with reference to the figures. Individual features of the embodiment shown can also be used in other embodiments, unless this has been expressly excluded. The figures show

FIG. 1 is a wheel end;

FIG. 2 is a hub cap; and

FIG. 3 is an information system.

### DETAILED DESCRIPTION OF THE PREFERRED EMBODIMENTS

FIG. 1 shows a wheel end 1, wherein the sectional view lies in a sectional plane which is spanned by the radial direction R and the axle of rotation 14. The wheel end 1 has a hub cap 2, which shields an opening in the hub 10 from the outside. The wheel bearing arrangement 16, which in this case is formed by two roller bearings, is arranged inside this opening in the hub 10. The rolling bearings are spaced apart in the direction of the axle of rotation 14, which can also be referred to as the axial direction. The wheel bearing arrangement 16 supports the axle end 14 in such a way that it can rotate about the axle of rotation 14 in relation to the hub 10. Alternatively, the axle end 12 can also be stationary and the hub 10 can rotate about the axle of rotation 14 relative to the axle end 12. The hub cap 2 is fixed to the hub 10 by a snap-in connection, wherein a seal 29 is provided between the hub 10 and the hub cap 2 in order to protect the interior of the wheel end 1 or the hub cap 2 against the effects of the weather. The NFC tag 30 of the wheel hub 1 lies on the axle of rotation 14 and is intersected by the axle of rotation 14. The NFC tag 30 is irreversibly fixed to the hub cap 2 by an adhesive bond.

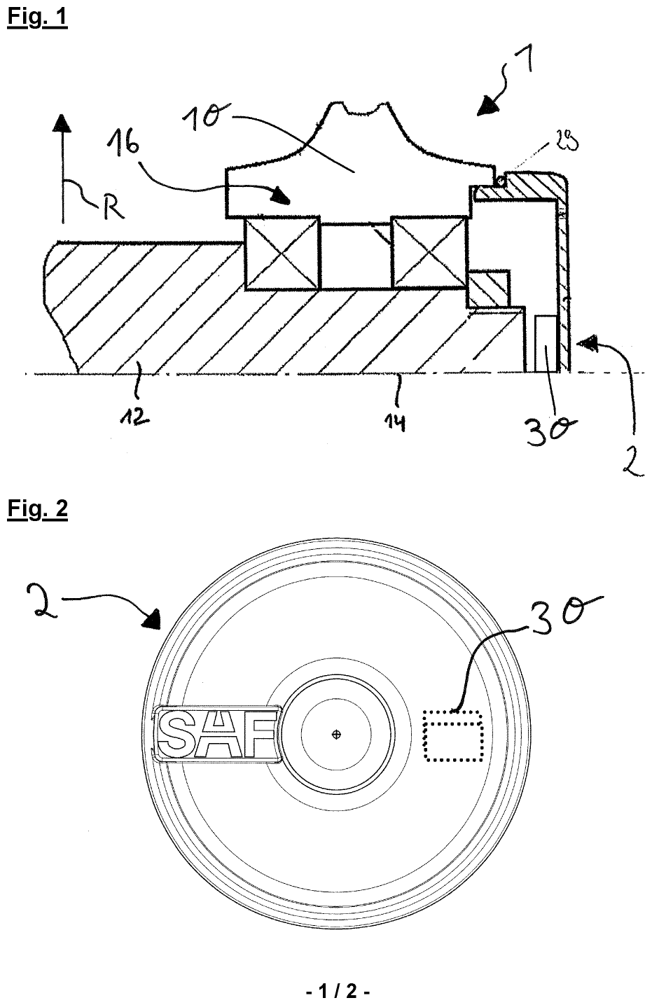

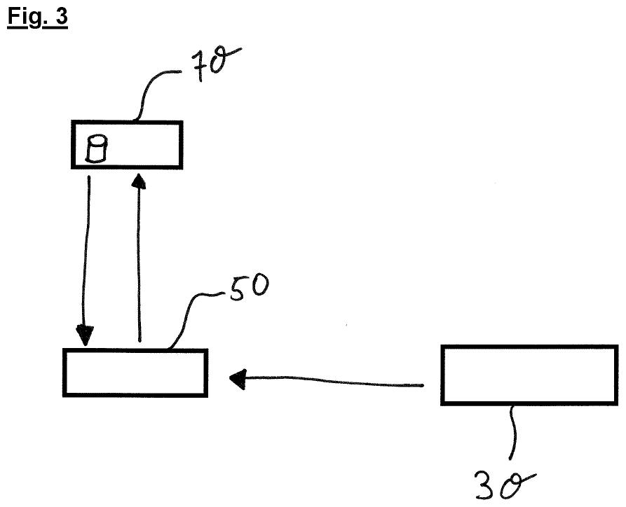

FIG. 2 shows an embodiment of a hub cap 2. As can be seen in FIG. 2, the NFC tag is fixed to the hub cap 2 at a distance from the axle of rotation 14 in the radial direction R.

FIG. 3 shows an information system. The information system comprises, among other things, an NFC tag 30, which can be fixed to a commercial vehicle, for example, an information retrieval unit 50 and a central unit 70. As indicated in FIG. 3, the central unit 70 has an information memory in the form of a mass memory in which certain data is stored ready for retrieval. The information retrieval unit 50 can retrieve information from the NFC tag 30 and transmit a request to the central unit 70 on the basis of this information, in particular via a wireless connection. Based on the received information and/or the query from the information retrieval unit 50, the central unit 70 transmits data from the mass memory to the information retrieval unit 50. The mass memory of the central unit 70 can be in the form of a database and/or a hard disk. By using a database, particularly fast and secure access to the stored data can be achieved. The data transmissions between the NFC tag 30 and the information retrieval unit 50 and/or the data transmission between the central unit 70 and the information retrieval unit 50 are advantageously carried out in a coded or encrypted form, so that data security can be further increased as a result. Alternatively or additionally preferably, the data streams can also be compressed, so that the amount of data that can be transmitted can be increased in a simple and reliable manner.

### LIST OF REFERENCE SYMBOLS

1—Wheel end
2—Hub cap
10—Hub
12—Axle end
14—Axle of rotation
16—Wheel bearing arrangement
29—Seal
30—NFC tag
50—Information retrieval unit
70—Central unit
R—Radial direction

1.-14. (canceled)

15. A commercial vehicle wheel end, comprising:
a wheel bearing arrangement, a hub, a hub cap and an NFC tag;
wherein the hub is held rotatably about an axle of rotation by the wheel bearing arrangement;
wherein the hub cap is fixed to the hub;
wherein the NFC tag is mounted on the hub cap or the hub; and
wherein the hub cap comprises plastic.

16. The wheel end according to claim 15, wherein the NFC tag is mounted via an adhesive bond, and/or is irreversibly mounted.

17. The wheel end according to claim 15, wherein the NFC tag comprises a passive tag.

18. The wheel end according to claim 15, wherein the NFC tag comprises a low frequency tag or a high frequency tag.

19. The wheel end according to claim 15, wherein the wheel end has an axle end of an axle, wherein the axle end is spaced at least 2 cm from the NFC tag and/or wherein the NFC tag is mounted directly or indirectly on the axle end.

20. The wheel end according to claim 19, wherein the axle end is spaced at least 4 cm from the NFC tag.

21. The wheel end according to claim 20, wherein the axle end is spaced at least 6 cm from the NFC tag.

22. The wheel end according to claim 15, wherein the NFC tag lies on the axle of rotation or is intersected by the axle of rotation.

23. The wheel end according to claim 15, wherein the NFC tag is mounted on the hub cap on a side facing the axle and/or on an inner side of the hub cap.

24. The wheel end according to claim 15, wherein a seal is arranged between the hub cap and the hub.

25. The wheel end according to claim 15, wherein the hub has through openings, and wherein the NFC tag is mounted in or in close proximity to a through opening.

26. A commercial vehicle comprising a wheel end according to claim 15.

27. The commercial vehicle according to claim 26, wherein the commercial vehicle comprises a trailer.

28. The commercial vehicle according to claim 27, wherein the commercial vehicle comprises a semi-trailer.

29. An identification system for identifying a wheel end component, comprising:
the wheel end according to claim 15; and
an information retrieval unit that includes a smartphone;
wherein the NFC tag is configured to transmit information concerning the wheel end or a component of the wheel end to the information retrieval unit.

30. An information system, comprising:
the identification system according to claim 29; and
a central unit that includes a server;
wherein the information retrieval unit is configured to transmit the information received from the NFC tag or parts or all of the information received from the NFC tag to the central unit, and/or wherein the central unit is configured to access an information memory including a database of the central unit on the basis of the information received from the information retrieval unit and to transmit data from the information memory to the information retrieval unit as a function of the information received from the information retrieval unit.

31. A wheel end, comprising:
a hub cap and an NFC tag;
wherein the NFC tag is mounted on the hub cap via a material bond; and
wherein the hub cap comprises plastic.

32. A commercial vehicle comprising the wheel end according to claim 31.

33. The commercial vehicle according to claim 32, wherein the commercial vehicle comprises a trailer.

34. The commercial vehicle according to claim 33, wherein the commercial vehicle comprises a semi-trailer.

35. An identification system for identifying a wheel end component, comprising:
the wheel end according to claim 31; and
an information retrieval unit that includes a smartphone;
wherein the NFC tag is configured to transmit information concerning the wheel end or a component of the wheel end to the information retrieval unit.

36. An information system, comprising:
the identification system according to claim 35; and
a central unit that includes a server;
wherein the information retrieval unit is configured to transmit the information received from the NFC tag or parts or all of the information received from the NFC tag to the central unit, and/or wherein the central unit is configured to access an information memory including a database of the central unit on the basis of the information received from the information retrieval unit and to transmit data from the information memory to the information retrieval unit as a function of the information received from the information retrieval unit.
